(19) United States
(12) Patent Application Publication
(10) Pub. No.: US 2022/0338015 A1
(43) Pub. Date: Oct. 20, 2022

(54) AUTHENTICATION SYSTEM, AUTHENTICATION METHOD AND PROGRAM

(71) Applicant: Nippon Telegraph and Telephone Corporation, Tokyo (JP)

(72) Inventor: Seiji YOSHIDA, Musashino-shi, Tokyo (JP)

(21) Appl. No.: 17/641,008

(22) PCT Filed: Sep. 12, 2019
(86) PCT No.: PCT/JP2019/035884

§ 371 Date: Mar. 7, 2022

(51) Int. Cl. H04W 12/63; H04W 12/06; G01S 19/20

(52) U.S. Cl. CPC H04W 12/63; H04W 12/06; G01S 19/20

(57) ABSTRACT

An authentication system that performs authentication of first location information collected from an apparatus includes an acquisition section configured to acquire one or more pieces of authentication information to be used for the authentication, and an authentication section that determines, using the one or more pieces of authentication information acquired by the acquisition section, whether the first location information is counterfeited, by an authentication method corresponding to each of the one or more pieces of authentication information to authenticate the first location information.

### TECHNICAL FIELD

The present invention relates to an authentication system, an authentication method and a program.

### BACKGROUND ART

An apparatus that tracks travel routes and the like through position measurement and time synchronization by receiving signals from global navigation satellite system (GNSS) satellites using radio waves is known. Such an apparatus is called a GNSS tracker, a GNSS logger, or the like, and is used for vehicle routing systems and traffic control systems, for example.

Incidentally, an apparatus called a GNSS pseudo signal generator or a GNSS simulator capable of generating a pseudo signal that simulates a GNSS signal is known. Because GNSS satellite orbit information is published in real time on the Internet, it is possible to counterfeit location information using GNSS pseudo signal generators or the like, which has caused problems. In particular, it has been possible to realize, at low cost, GNSS pseudo signal generators capable of simulating satellite signals from a plurality of satellite positioning systems at the same time with spread of software defined radio (SDR) in recent years, and it has become easier to counterfeit location information.

In this regard, road pricing of dynamically charging for passing of vehicles through roads depending on the time of day, mechanisms for charging for traffic lanes, and the like have been studied in recent years, and there is a concern of improper utilization or the like due to counterfeiting of location information. In addition, although services of providing traffic congestion information from vehicle tracking information collected using cloud-type car navigation services are known, there is a concern about attacks that could lead to provide false traffic congestion information by sending a large amount of tracking information of vehicles with spoofed location information.

Position authentication technique for guaranteeing that location information is correct by authenticating the location information against counterfeiting of location information as described above has been proposed (see NPL 1, for example).

### CITATION LIST

### Non Patent Literature

NPL 1: Yasuhiro Koyama et al., “Development of position authentication technique test system,” Japan Geoscience Union Meeting, May 16, 2006

### SUMMARY OF THE INVENTION

### Technical Problem

However, because there is a concern that counterfeiting of location information will become increasingly sophisticated in the future, it is necessary to prepare a mechanism for authenticating location information with higher precision.

An embodiment of the present invention is made in view of the aforementioned point, and an object thereof is to authenticate location information with high precision.

### Means for Solving the Problem

In order to achieve the aforementioned object, an authentication system according to an embodiment is an authentication system that performs authentication of first location information collected from an apparatus, the authentication system including an acquisition section that acquires one or more pieces of authentication information to be used for the authentication, and an authentication section that determines, using the one or more pieces of authentication information acquired by the acquisition section, whether the first location information is counterfeited, by an authentication method corresponding to each of the one or more pieces of authentication information to authenticate the first location information.

### Effects of the Invention

It is possible to authenticate location information with high precision.

### BRIEF DESCRIPTION OF DRAWINGS

FIG. 1 is a diagram illustrating an example of an overall configuration of an authentication system according to an embodiment.

FIG. 2 is a diagram illustrating an example of a hardware configuration of an authentication apparatus according to the embodiment.

FIG. 3 is a diagram illustrating an example of a hardware configuration of a tracking apparatus according to the embodiment.

FIG. 4 is a diagram illustrating an example of a functional configuration of the authentication system according to the embodiment.

FIG. 5 is a diagram illustrating an exemplary flow of processing for collecting location information and time information according to the embodiment.

FIG. 6 is a diagram illustrating an exemplary flow of authentication processing according to the embodiment.

### DESCRIPTION OF EMBODIMENTS

Hereinafter, an embodiment of the present invention (hereinafter, also referred to as “the present embodiment”) will be described. In the present embodiment, an authentication system 1 capable of authenticating location information measured by receiving signals from GNSS satellites with high precision will be described.

### Overall Configuration

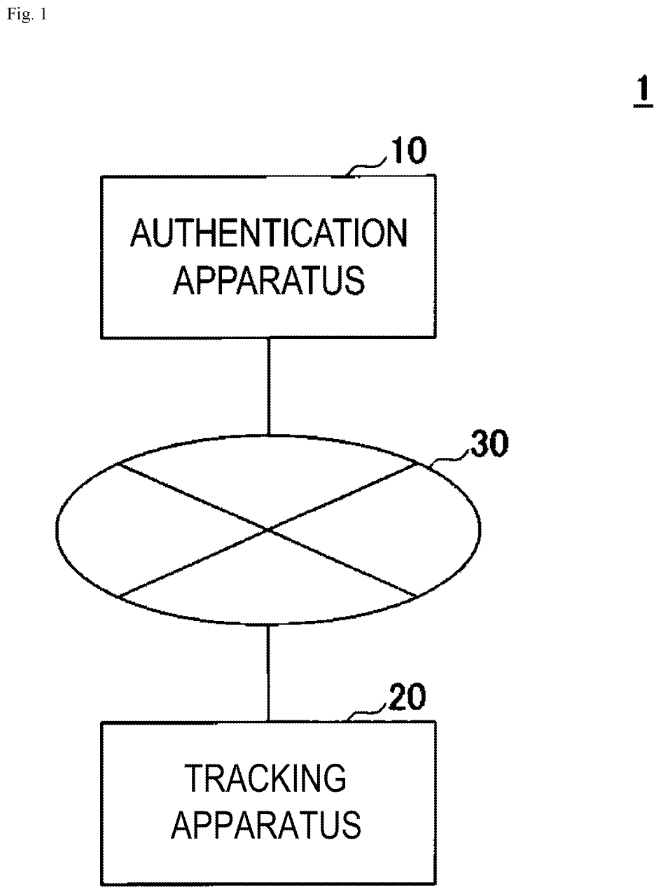

First, an overall configuration of the authentication system 1 according to the present embodiment will be described with reference to FIG. 1. FIG. 1 is a diagram illustrating an example of the overall configuration of the authentication system 1 according to the present embodiment.

As illustrated in FIG. 1, the authentication system 1 according to the present embodiment includes an authentication apparatus 10 and one or more tracking apparatuses 20. The authentication apparatus 10 and each tracking apparatus 20 are communicably connected via a communication network 30 including a mobile phone network, the Internet, or the like.

The tracking apparatus 20 is an apparatus that is also called a GNSS tracker or a GNSS logger and is capable of tracking travel routes thereof. The tracking apparatus 20 is mounted on or carried by a moving object (a vehicle, a person, and the like). For example, the tracking apparatus 20 may be mounted on or brought to a vehicle or may be carried by a pedestrian.

The tracking apparatus 20 receives signals from the GNSS satellites using radio waves every predetermined time period (every one second, for example) to perform measurement of location information and synchronization of time information. In addition, the tracking apparatus 20 transmits the location information and the time information to the authentication apparatus 10 at a predetermined time period interval (every several seconds to several tens of seconds, for example). Routes through which the tracking apparatus 20 has moved (that is, travel routes) are tracked through the measurement of the location information and the synchronization of the time information. However, the tracking apparatus 20 may transmit the location information and the time information to the authentication apparatus 10 at a predetermined timing (at a time determined in advance (for example, a time at which provision of a transport service ends in a case in which the tracking apparatus 20 is mounted in a vehicle for a transport service) or when a user operation is performed).

Note that the tracking apparatus 20 is not limited to the GNSS tracker or the GNSS logger and may be any one or ones of various apparatuses, terminals, or the like capable of functioning as the GNSS tracker (or the GNSS logger). For example, the tracking apparatus 20 may be a smartphone, a tablet terminal, an in-vehicle device, a wearable device, a mobile game console, or the like in which an application program for implementing a function of the GNSS tracker (or the GNSS logger) has been installed.

The authentication apparatus 10 is a computer or a computer system that receives (collects) the location information and the time information from the tracking apparatus 20 and authenticates the location information at the times indicated by the time information. The authentication of the location information involves checking whether the location information is correct at the time indicated by the time information (that is, whether the position indicated by the location information represents actual position of the tracking apparatus 20 at the time).

At this time, the authentication apparatus 10 authenticates the location information using various kinds of information such as traffic light state information representing a lighting state of a traffic light and road state information representing a temporary traffic restriction of a road as will be described below. The authentication apparatus 10 according to the present embodiment can thus authenticate the location information with high precision. Thus, the authentication apparatus 10 according to the present embodiment can detect, in a case in which the location information collected from the tracking apparatus 20 has been counterfeited, for example, the counterfeiting with high precision. Note that each piece of location information (or location information for each time period or the like) is authenticated, and routes represented by the pieces of location information are also thereby authenticated.

Hereinafter, various kinds of information used to authenticate location information (for example, the traffic light state information, the road state information, and the like) will also be referred to as “authentication information”. The authentication information includes, in addition to the traffic light state information and the road state information, rail crossing state information representing an open/closed state of a crossing bar at a rail crossing, communication log information including an identifier (for example, a service set identifier (SSID) or the like) of a mobile base station, a wireless local area network (LAN) access point or the like used by the tracking apparatus 20, reception state information representing a reception state of radio waves from the GNSS satellites at a specific point, and the like as will be described below.

Note that the overall configuration of the authentication system 1 illustrated in FIG. 1 is only an example and it may have another configuration. For example, the authentication system 1 according to the present embodiment may include a plurality of authentication apparatuses 10.

### Hardware Configuration

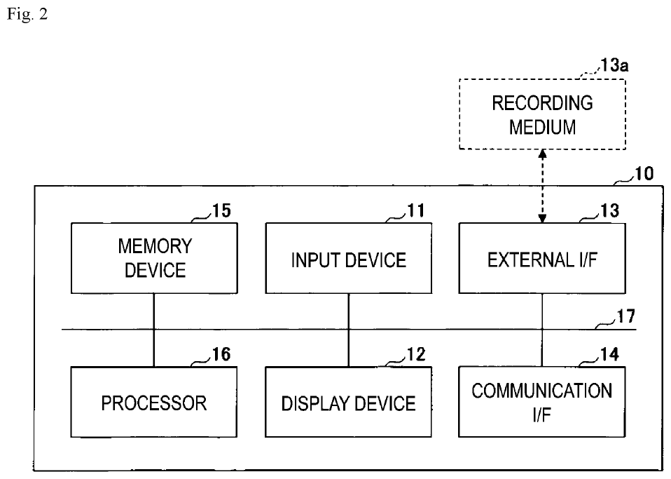

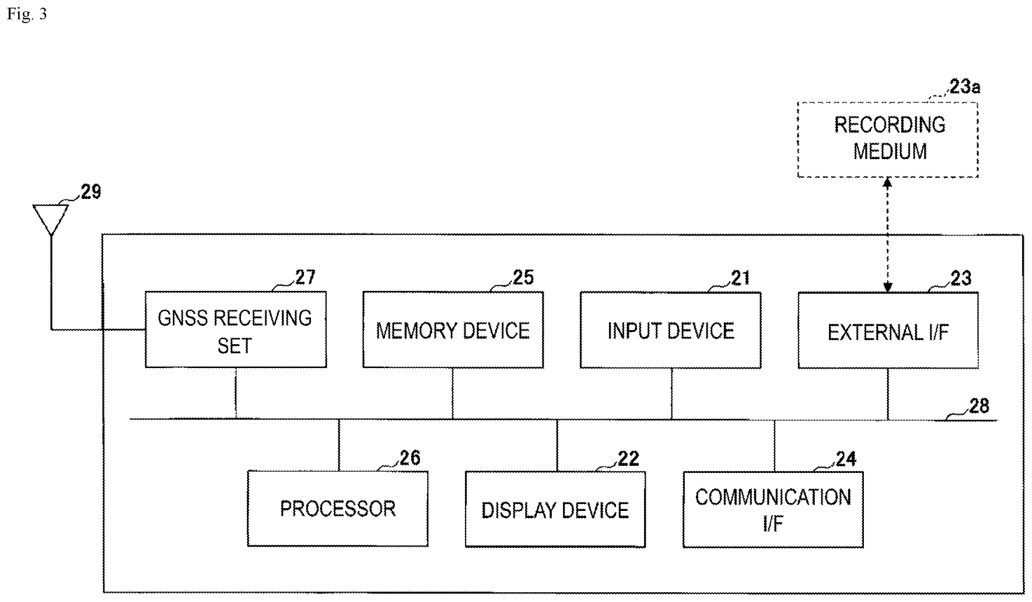

Next, hardware configurations of the authentication apparatus 10 and the tracking apparatus 20 included in the authentication system 1 according to the present embodiment will be described with reference to FIGS. 2 and 3, respectively. FIG. 2 is a diagram illustrating an example of the hardware configuration of the authentication apparatus 10 according to the present embodiment. FIG. 3 is a diagram illustrating an example of the hardware configuration of the tracking apparatus 20 according to the present embodiment.

### Authentication Apparatus 10

As illustrated in FIG. 2, the authentication apparatus 10 according to the present embodiment includes an input device 11, a display device 12, an external I/F 13, a communication I/F 14, a memory device 15, and a processor 16. The hardware of these components is mutually communicably connected via a bus 17.

The input device 11 is, for example, a keyboard, a mouse, a touch panel, various operation buttons, or the like. The display device 12 is, for example, a display. Note that the authentication apparatus 10 need not have at least either the input device 11 or the display device 12.

The external I/F 13 is an interface with an external device such as a recording medium 13a. The recording medium 13a is, for example, a CD, a DVD, an SD memory card, or a USB memory.

The communication I/F 14 is an interface for connecting the authentication apparatus 10 to the communication network 30. The memory device 15 includes any one or ones of various storage devices such as a random access memory (RAM), a read only memory (ROM), a flash memory, a hard disk drive (HDD), and a solid state drive (SSD). The processor 16 is, for example, any of various arithmetic operation devices such as a central processing unit (CPU).

The authentication apparatus 10 according to the present embodiment can implement various kinds of processing, which will be described below, by having the hardware configuration illustrated in FIG. 2. Note that the hardware configuration illustrated in FIG. 2 is only an example and the authentication apparatus 10 according to the present embodiment may have another hardware configuration. For example, the authentication apparatus 10 according to the present embodiment may have a plurality of memory devices 15 and may have a plurality of processors 16.

### Tracking Apparatus 20

As illustrated in FIG. 3, the tracking apparatus 20 according to the present embodiment includes an input device 21, a display device 22, an external I/F 23, a communication I/F 24, a memory device 25, a processor 26, and a GNSS receiving set 27. The hardware of these components is mutually communicably connected via a bus 28.

The input device 21 is, for example, a touch panel or various operation buttons. The display device 22 is, for example, a display. Note that the tracking apparatus 20 need not have at least either the input device 21 or the display device 22.

The external I/F 23 is an interface with an external device such as a recording medium 23a. The recording medium 23a is, for example, an SD memory card, a USB memory, or the like.

The communication I/F 24 is an interface for connecting the tracking apparatus 20 to the communication network 30. The memory device 25 includes any one or ones of various storage devices such as a RAM, a ROM, and a flash memory. The processor 26 is any of various arithmetic operation devices such as a CPU and a micro processing unit (MPU). The GNSS receiving set 27 is also called a GNSS receiver and is an apparatus or a module that receives, using radio waves, signals from the GNSS satellites using a GNSS antenna 29 connected via a coaxial cable or the like and performs measurement of location information and synchronization of time information.

The tracking apparatus 20 according to the present embodiment has the hardware configuration illustrated in FIG. 3 and can implement various kinds of processing, which will be described below. Note that the hardware configuration illustrated in FIG. 3 is only an example, and the tracking apparatus 20 according to the present embodiment may have another hardware configuration. For example, the tracking apparatus 20 according to the present embodiment may have a plurality of memory devices 25 and may have a plurality of processors 26.

### Functional Configuration

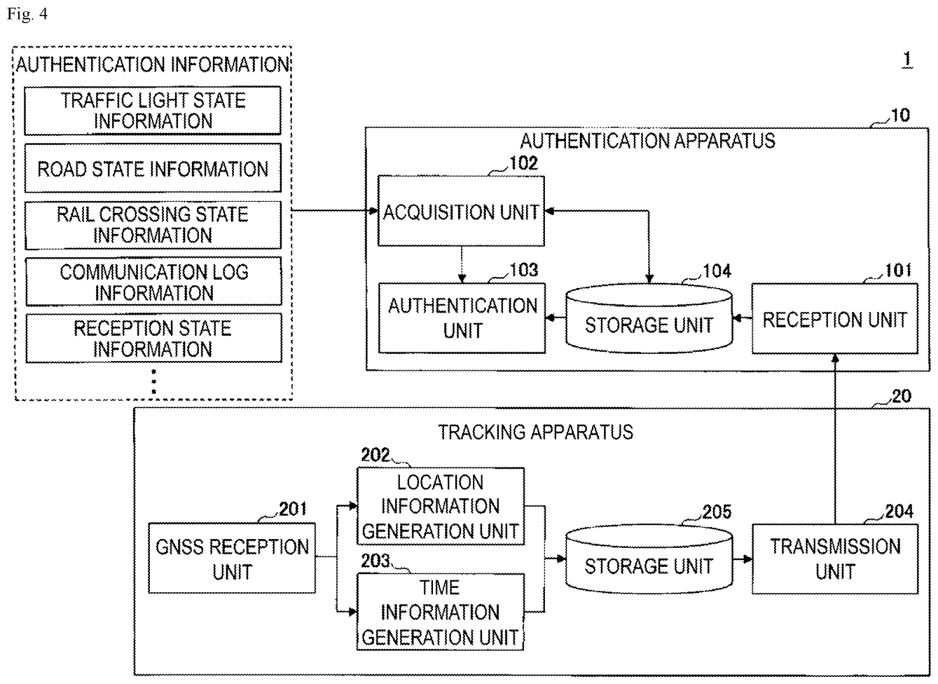

Next, a functional configuration of the authentication system 1 according to the present embodiment will be described with reference to FIG. 4. FIG. 4 is a diagram illustrating an example of the functional configuration of the authentication system 1 according to the present embodiment.

### Tracking Apparatus 20

As illustrated in FIG. 4, the tracking apparatus 20 according to the present embodiment includes a GNSS reception unit 201, a location information generation unit 202, a time information generation unit 203, and a transmission unit 204. Each of these components is implemented by causing the processor 26 to execute one or more programs stored in the memory device 25, for example.

In addition, the tracking apparatus 20 according to the present embodiment has a storage unit 205. The storage unit 205 can be implemented using the memory device 25, for example.

The GNSS reception unit 201 receives signals from the GNSS satellites using radio waves every predetermined time period (every one second, for example). Note that the GNSS reception unit 201 typically receives signals from a plurality of GNSS satellites (four or more GNSS satellites, for example) using radio waves.

The location information generation unit 202 measures a position (for example, a latitude, longitude, an altitude, and the like) from a signal received by the GNSS reception unit 201 and generates location information indicating the position. The location information generated by the location information generation unit 202 is stored in the storage unit 205. Note that the location information generation unit 202 may measure the position by any positioning scheme such as code-based positioning or interference positioning (carrier-phase-based positioning), for example. However, an error less than or equal to 1 meter from a true value is assumed as precision of the positioning in the present embodiment.

The time information generation unit 203 uses the signal received by the GNSS reception unit 201 to synchronize the time to a coordinated universal time (UTC) and generates time information indicating the synchronized time or a time obtained by converting the time into a predetermined standard time (Japan standard time (JST), for example). The time information generated by the time information generation unit 203 is stored in the storage unit 205. Note that an error less than or equal to 1 millisecond from a true value is assumed as precision of the time synchronization in the present embodiment.

The transmission unit 204 transmits the location information and the time information stored in the storage unit 205 to the authentication apparatus 10 every predetermined time period (every several seconds to several tens of seconds, for example). At this time, the transmission unit 204 transmits, to the authentication apparatus 10, location information and time information during the corresponding time period (that is, several seconds to several tens of seconds, for example) from among the location information and the time information stored in the storage unit 205, for example. In this regard, the location information and the time information are stored in an associated manner in the storage unit 205. In other words, in a case in which the GNSS reception unit 201 receives signals from the GNSS satellites every predetermined time period (every one second, for example), location information and time information generated from signals received during the time period (that is, during one second, for example) are stored in an associated manner in the storage unit 205. Thus, the position of the tracking apparatus 20 at the time indicated by the time information is represented by the pair of the location information and the time information.

### Authentication Apparatus 10

As illustrated in FIG. 4, the authentication apparatus 10 according to the present embodiment includes a reception unit 101, an acquisition unit 102, and an authentication unit 103. Each of these components is implemented by causing the processor 16 to execute one or more programs stored in the memory device 15.

In addition, the authentication apparatus 10 according to the present embodiment includes a storage unit 104. The storage unit 104 is implemented using the memory device 15, for example. Note that the storage unit 104 may be implemented using a storage apparatus or the like connected to the authentication apparatus 10 via the communication network 30, for example.

The reception unit 101 receives the location information and the time information transmitted from the tracking apparatus 20. The location information and the time information received by the reception unit 101 are stored in the storage unit 104. In this manner, the location information and the time information are collected from the tracking apparatus 20.

The acquisition unit 102 acquires one or more pieces of authentication information for authenticating the location information. In this regard, the acquisition unit 102 may acquire each of the one or more pieces of authentication information from any acquisition source. For example, the acquisition unit 102 may acquire the authentication information from an external server, an external system, or the like that manages the authentication information in accordance with the type of authentication information. Alternatively, in a case in which the authentication information is stored in the storage unit 104, for example, the acquisition unit 102 may acquire the authentication information from the storage unit 104. Note that the authentication information acquired from the external server, the external system, or the like may be stored in the storage unit 104.

The authentication unit 103 authenticates the location information stored in the storage unit 104 using the one or more pieces of authentication information acquired by the acquisition unit 102. Note that the result of authenticating the location information may be stored in the storage unit 104 or may be transmitted to a predetermined terminal connected to the authentication apparatus 10 via the communication network 30, for example.

### Processing Flow

Next, a flow of processing performed by the authentication system 1 according to the present embodiment will be described.

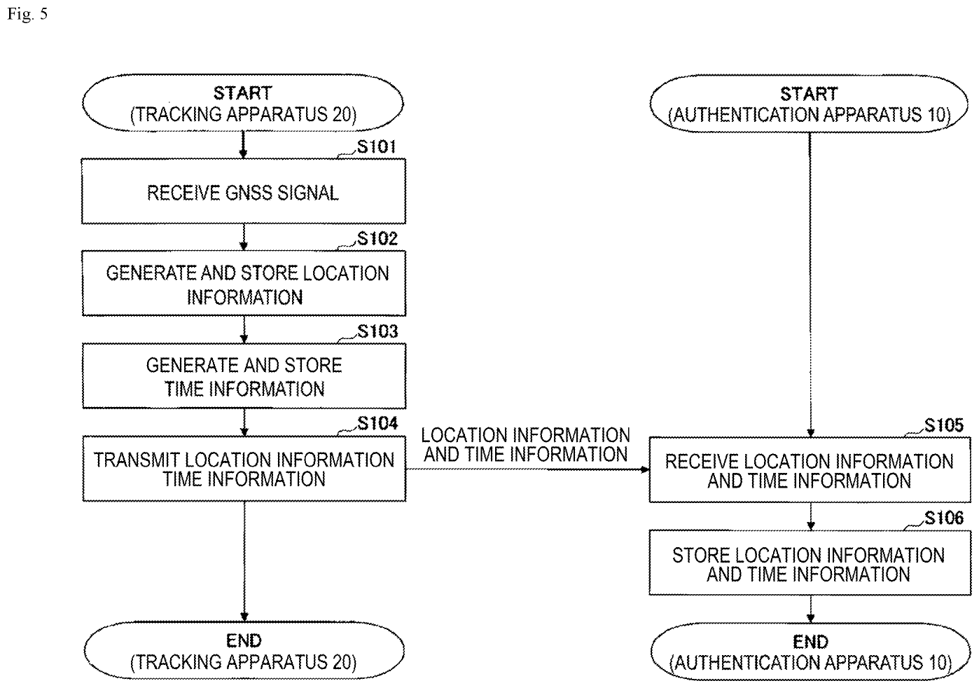

Processing of Collecting Location information and Time Information Hereinafter, the processing of the tracking apparatus 20 generating location information and time information and the processing of the authentication apparatus 10 collecting the location information and the time information will be described with reference to FIG. 5. FIG. 5 is a diagram illustrating an exemplary flow of processing of collecting the location information and the time information according to the present embodiment.

First, the GNSS reception unit 201 of the tracking apparatus 20 receives signals from the GNSS satellites using radio waves every predetermined time period (every second, for example) (Step S101).

Next, the location information generation unit 202 of the tracking apparatus 20 measures the position from the signal received in Step S101 described above and generates location information indicating the position. Then, the location information generation unit 202 stores the generated location information in the storage unit 205 (Step S102).

Next, the time information generation unit 203 of the tracking apparatus 20 uses the signal received in Step S101 described above to synchronize the time to the coordinated universal time and generates time information indicating the synchronized time or a time obtained by converting the time into a predetermined standard time. Then, the time information generation unit 203 stores the generated time information in the storage unit 205 (Step S103).

Note that Step S102 and Step S103 described above may be performed in any order. In other words, Step S102 described above may be executed after Step S103 described above is executed.

Next, the transmission unit 204 of the tracking apparatus 20 transmits, to the authentication apparatus 10, the location information and the time information stored in the storage unit 205 every predetermined time period (every several seconds to several tens of seconds, for example) (Step S104).

Note that, in Step S104 described above, the transmission unit 204 may transmit identification information (an apparatus ID, for example) for identifying the tracking apparatus 20. In this manner, the location information and the time information are stored in the storage unit 104 of the authentication apparatus 10 for each apparatus ID in Step S106, which will be described below.

In addition, the transmission unit 204 may transmit a reception state (for example, an S/N ratio, a reception intensity, or whether multipath propagation has been occurred) of the radio waves of the time when the signal used to generate the location information and the time information is received or may transmit data indicating a pseudorange measurement result that is also called observational data or raw data, in Step S104 described above. In this manner, the reception state or the observational data is stored in the storage unit 104 of the authentication apparatus 10 in association with the location information and the time information in Step S106, which will be described below. In this regard, because it is possible to determine that multipath propagation has been occurred in a case in which there are a plurality of peaks in a reception intensity in a certain time period after correlation signal processing of the GNSSs, for example, whether multipath propagation has been occurred need not be included as the reception state. Note that the multipath propagation is also called multiple-wave propagation and indicates a phenomenon in which two or more propagation paths are generated at a reception position by radio waves from the GNSS satellites being reflected or diffracted by surrounding structure, ground, or the like.

The reception unit 101 of the authentication apparatus 10 receives the location information and the time information transmitted by the tracking apparatus 20 in Step S104 described above (Step S105).

Next, the reception unit 101 of the authentication apparatus 10 stores, in the storage unit 104, the location information and the time information received in Step S105 described above (Step S106). In this manner, the authentication apparatus 10 can collect the location information and the time information from each tracking apparatus 20.

### Authentication Processing

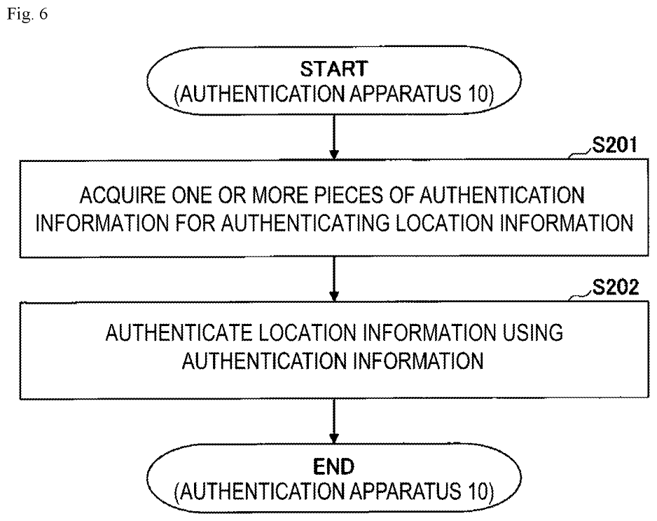

Hereinafter, processing performed by the authentication apparatus 10 to authenticate the location information collected from the tracking apparatus 20 will be described with reference to FIG. 6. FIG. 6 is a diagram illustrating a flow of an example of the authentication processing according to the present embodiment. Note that the authentication processing illustrated in FIG. 6 may be executed every time period determined in advance or may be executed in response to an instruction from a user of the authentication apparatus 10 or an instruction from a user of a terminal connected to the authentication apparatus 10 via the communication network 30.

First, the acquisition unit 102 of the authentication apparatus 10 acquires one or more pieces of authentication information to authenticate the location information (Step S201). For example, the acquisition unit 102 acquires, as the authentication information, at least one or more pieces of information from among traffic light state information, road state information, rail crossing state information, communication log information, and reception state information. In this regard, in a case in which the authentication information is stored in the storage unit 104 as described above, the acquisition unit 102 may acquire the authentication information from the storage unit 104. On the other hand, in a case in which the authentication information is not stored in the storage unit 104, the acquisition unit 102 may acquire the authentication information from an external server, an external system, or the like that manages the authentication information, in accordance with the type of authentication information, for example.

Note that examples of the external server or the external system that manages the traffic light state information, the road state information, and the rail crossing state information include a server, a system, and the like that manage the information as traffic information. In addition, examples of the external server or the external system that manages the communication log information include a data center server, an operation system, and the like of a communication carrier. Further, examples of the external server or the external system that manages the reception state information include a server and the like that simulate radio waves from each GNSS satellite at each point in a 3D space (that is, ray-tracing simulation).

Next, the authentication unit 103 of the authentication apparatus 10 authenticates the location information using the authentication information acquired in Step 5201 described above (Step S202). In this regard, the authentication unit 103 authenticates the location information by at least one or more authentication methods from among the following authentication methods 1 to 7, for example. Note that each piece of location information (or location information for each time period or the like) is authenticated, and routes represented by the pieces of location information are also thereby authenticated.

### Authentication Method 1: Authentication Using Traffic Light State Information

The traffic light state information is information representing a lighting state of a traffic light and includes at least lighting state information indicating a lighting state of the traffic light at each time, location information indicating the position where the traffic light is placed, and orientation information indicating a front direction of the traffic light, for example. Note that the lighting state of the traffic light at each time includes, for example, red representing stop of traveling, green representing permission of traveling, and yellow representing transition from the permission of traveling to the stop of traveling, but these colors are only examples. In addition, in the case of a traffic light for pedestrians, the lighting state is either red or green in many cases. It is possible to determine whether a vehicle or a pedestrian (that is, a vehicle in which the tracking apparatus 20 is mounted or a person who carries the tracking apparatus 20, for example) should stop at each time within a range in which the traffic light controls the traffic (that is, within the range in the front direction of the traffic light) using the traffic light state information.

In this case, the authentication unit 103 can thus authenticate the location information using the traffic light state information of the traffic light on the route represented by the location information and the time information. More specifically, in a case in which lighting state information of certain traffic light state information in a certain time period is a color representing stop of traveling, and when location information located in the front direction of the traffic light corresponding to the traffic light state information passes through the traffic light (that is, when the location information passes through the traffic light regardless of the red traffic light on a route represented by each piece of location information in the certain time period), for example, the authentication unit 103 determines that the location information has been counterfeited. In this regard, passing through the traffic light means that the location information of the tracking apparatus 20 located in the front direction of the traffic light and within a predetermined range (within a range of several meters to a hundred and several tens of meters, for example) from the location information of the traffic light moves in a direction opposite to the front direction of the traffic light or moves in a direction orthogonal to the front direction of the traffic light during the certain time period.

Then, in a case in which the location information is not determined to have been counterfeited, the authentication unit 103 authenticates the location information. Alternatively, the authentication unit 103 may statistically analyze a moving speed of each vehicle in the same traveling direction in a case in which the lighting state of the traffic light is a color representing permission of traveling within a predetermined area including an intersection where the traffic light is placed and determine location information of a vehicle with a significant difference in the moving speed from the other vehicles as having been counterfeited, for example.

Note that the authentication unit 103 may perform the aforementioned determination using traffic light state information of all traffic lights on the route represented by each piece of location information that is a target of authentication or may perform the aforementioned determination using only traffic light state information of some traffic lights determined in advance. Further alternatively, although the traffic light state information is assumed to be acquired from an external server or an external system, traffic light state information may be generated by collecting images of traffic lights at certain times captured by various cameras (for example, cameras mounted in vehicles, fixed point observation cameras placed near the traffic lights, or the like) using cloud sourcing or the like and analyzing the images, for example. In addition, the traffic light state information may be created by collecting pieces of location information of vehicles or pedestrians using cloud sourcing or the like and statistically estimating the lighting state of the traffic light from these pieces of location information, for example.

### Authentication Method 2: Authentication Using Road State Information

The road state information is information representing a temporary traffic restriction or the like of a road due to construction, for example, and includes at least traffic availability information indicating traffic availability of the road at each time and road information indicating the road. Note that the road information may be link information configuring a road network, information for specifying the link information (a link number, for example), or coordinate sequence information representing the link information, for example. In addition, the traffic availability information may be information indicating traffic availability in units of link information or may be information indicating traffic availability in units of each coordinate of the coordinate sequence information representing the link information. It is possible to determine whether the vehicle or the pedestrian (that is, the vehicle in which the tracking apparatus 20 is mounted or the person who carries the tracking apparatus 20, for example) can pass through a corresponding road at each time using the road state information. More specifically, in a case in which the location information in a certain time period is located on a road through which traveling is not allowed (that is, in a case in which the route represented by each piece of location information includes a road through which passing is not allowed in the certain time period), for example, the authentication unit 103 determines that the location information has been counterfeited. In this regard, the case in which the location information in the certain time period is on the road means that at least a part of the location information in the time period is superimposed on the coordinate sequence information of the link information specified by the road information, for example. Note that traffic availability of a certain road can be determined from the traffic availability information of the road state information corresponding to the road.

Then, in a case in which the location information is not determined to have been counterfeited, the authentication unit 103 authenticates the location information.

Note that the authentication unit 103 may perform the aforementioned determination using the road state information of all roads, may perform the aforementioned determination using only road state information indicating that passing is not possible, or may perform the aforementioned determination using only a part of the road state information indicating that passing is not possible.

In addition, the road state information is not limited to information representing a temporary traffic restriction or the like and may be, for example, information representing a traffic restriction due to an accident or the like, traffic congestion information, or the like. At this time, the traffic congestion information may be created by collecting location information of vehicles using cloud sourcing, for example. It is possible to determine that location information of a vehicle that is moving to pass another vehicle when many vehicles are decelerating or stopping is counterfeited location information, based on the location information collected using cloud sourcing or the like, for example, using the traffic congestion information as the road state information.

### Authentication Method 3: Authentication Using Rail Crossing State Information

The rail crossing state information is information representing an open/closed state of a crossing bar at a rail crossing and includes at least traffic availability information indicating traffic availability at the rail crossing at each time and location information indicating the position of the rail crossing, for example. It is possible to determine whether the vehicle or the pedestrian (that is, the vehicle in which the tracking apparatus 20 is mounted or the person who carries the tracking apparatus 20, for example) can pass across the rail crossing at each time, using the rail crossing state information. More specifically, in a case in which the location information in a certain time period passes across a rail crossing that is not allowed to pass (that is, in a case in which a route represented by each piece of location information in a certain time period includes the rail crossing that is not allowed to pass), for example, the authentication unit 103 determines that the location information has been counterfeited. In this regard, passing across the rail crossing means that the location information of the tracking apparatus 20 located within a predetermined range (for example, within a range of several meters to a hundred and several tens of meters) from the location information of the rail crossing overlaps (or can be regarded as overlapping a range that is significantly close to) the location information of the area between crossing bars of the rail crossing at least once in a certain time period. Moreover, passing across the rail crossing may include the location information of the tracking apparatus 20 within a predetermined range from the location information of the rail crossing moving over the area between the crossing bars of the rail crossing in the certain time period (that is, although the location information of the tracking apparatus 20 does not overlap the area, location information time has moved at a next time over the area relative to the location information at the certain time).

Then, in a case in which the location information is not determined to have been counterfeited, the authentication unit 103 authenticates the location information.

Note that the authentication unit 103 may perform the aforementioned determination using rail crossing state information of all rail crossings on the route represented by each piece of location information that is a target of the authentication or may perform the aforementioned determination using only rail crossing state information of some rail crossings determined in advance. In addition, the rail crossing state information may be generated by collecting images of rail crossings at certain times imaged by cameras mounted in the vehicles using cloud sourcing and analyzing the images, for example, similarly to the traffic light state information.

### Authentication Method 4: Authentication Using Communication Log Information

The communication log information is information including an identifier of a mobile base station, a wireless LAN access point, or the like used by the tracking apparatus 20, that is, information including the identification information of the tracking apparatus 20 when the tracking apparatus 20 uses (accesses) the mobile base station or the wireless LAN access point, the identifier of the mobile base station or the access point, and the time at which the mobile base station or the access point is accessed. It is possible to determine whether the tracking apparatus 20 uses the corresponding mobile base station or access point at a certain time, using the communication log information. In this manner, it is possible to determine whether the vehicle in which the tracking apparatus 20 is mounted, the person who carries the tracking apparatus 20, or the like is present within a range in which the mobile base station or the access point can be used (accessible range). More specifically, in a case in which the communication log information corresponding to the location information (that is, the communication log information including the identification information of the corresponding tracking apparatus 20, the identifier of the mobile base station or the access point used when the tracking apparatus 20 performs communication at the position indicated by the location information, and the time within the time period) is not present in the certain time period (the time period during which the transmission unit 204 performs transmission, for example), for example, the authentication unit 103 determines that the location information has been counterfeited. Then, in a case in which the location information is not determined to have been counterfeited, the authentication unit 103 authenticates the location information.

Note that the authentication unit 103 may perform the aforementioned determination every time period at which the transmission unit 204 performs transmission or may perform the aforementioned determination in some of time periods at which the transmission unit 204 performs transmission.

### Authentication Method 5: Authentication Using Reception State Information (Part 1)

The reception state information is information representing a reception state of radio waves from the GNSS satellites at a specific location. In the authentication method 5, the reception state information is assumed to be information indicating a signal-to-noise (SN) ratio, reception intensity, or the like of the radio waves of the signals from each GNSS satellite under an elevated structure or under an overpass, for example. Note that such reception state information is obtained by performing ray-tracing simulation of the radio waves from each GNSS satellite at each time at the specific point (under the elevated structure or under the overpass, for example) in the 3D space as described above. It is possible to determine whether the vehicle in which the tracking apparatus 20 is mounted, the person who carries the tracking apparatus 20, or the like has actually been at the specific point in a case in which the position indicated by the location information is the specific point (under the elevated structure or under the overpass, for example), using the reception state information. Note that because the GNSS pseudo signal generator, the GNSS simulator, or the like is typically adapted to generate GNSS pseudo signals in an open sky environment, it is difficult to imitate a reception state at a point under an elevated structure or under an overpass, for example. Thus, it is considered to be possible to determine whether the location information has been counterfeited with high precision by the authentication method 5.

More specifically, in a case in which the position indicated by the location information at a certain time is a specific point (under an elevated structure or under an overpass, for example), for example, the authentication unit 103 compares the reception state stored in association with the location information in the storage unit 104 with the reception state information indicating the reception state at the specific point at the time, and when the SN ratio or the reception intensity is different by a predetermined threshold value or more, the authentication unit 103 determines that the location information has been counterfeited. In other words, in a case in which the SN ratio or the reception intensity at the specific point (under the elevated structure or under the overpass, for example) collected from the tracking apparatus 20 is different from the SN ratio or the reception intensity obtained through the ray-tracing simulation by a predetermined threshold value or more, the authentication unit 103 determines that the location information has been counterfeited. Then, in a case in which the location information is not determined to have been counterfeited, the authentication unit 103 authenticates the location information.

Note that the authentication unit 103 may perform the aforementioned determination at all specific points (under elevated structures or under overpasses, for example) on the route represented by each piece of location information that is a target of the authentication or may perform the aforementioned determination at some of specific points determined in advance.

In addition, although the SN ratio obtained through the ray-tracing simulation inside the 3D space is compared with the reception state information collected from the tracking apparatus 20 in the above description, an embodiment is not limited thereto, and the aforementioned determination may be performed by comparing two-dimensional map data with the reception state information collected from the tracking apparatus 20, for example. In other words, whether the tracking apparatus 20 has actually passed the specific point may be determined by comparing a change in reception state information (the SN ratio, for example) between before or after, and during passing through the specific point (under the elevated structure or under the overpass, for example) in the two-dimensional map data with a change pattern of the reception state information in the case in which the tracking apparatus 20 actually passes the specific point, and whether the location information has been counterfeited may thus be determined.

### Authentication Method 6: Authentication Using Reception State Information (Part 2)

In the authentication method 6, the reception state information is defined as information indicating whether multipath propagation has been occurred due to presence of structures in the surroundings, for example. In other words, the reception state information is defined as information indicating whether multipath propagation occurs at each point at each time in the authentication method 6. Note that as described above, such reception state information is obtained by performing ray-tracing simulation of radio waves from each GNSS satellite at each time at each point in a 3D space. It is possible to determine whether multipath propagation occurs in a case in which radio waves are received from each GNSS satellite at the position indicated by the location information, using the reception state information. Therefore, it is possible to determine whether the vehicle in which the tracking apparatus 20 is mounted, the person who carries the tracking apparatus 20, or the like has actually been at the position in a case in which there is a structure (a building, for example) in the surroundings of the position indicated by the location information. Note that because the GNSS pseudo signal generator, the GNSS simulator, or the like is typically adapted to generate a GNSS pseudo signal in an open sky environment as described above, it is difficult to imitate occurrence of multipath propagation due to presence of structures such as a building, for example, in the surroundings. It is thus considered to be possible to determine whether location information has been counterfeited with high precision in the authentication method 6.

More specifically, the authentication unit 103 compares the reception state stored in association with the location information at a certain time in the storage unit 104 with the reception state information indicating the reception state at the specific point at the time, and when there is contradiction therebetween, the authentication unit 103 determines that the location information has been counterfeited. In other words, in a case in which the reception state stored in the storage unit 104 indicates that no multipath propagation has been occurred while the reception state information indicates that multipath propagation has been occurred, for example, the authentication unit 103 determines that the location information has been counterfeited. Then, in a case in which the location information is not determined to have been counterfeited, the authentication unit 103 authenticates the location information.

Note that the authentication unit 103 may perform the aforementioned determination at all points on the route represented by each piece of location information that is a target of the authentication or may perform the aforementioned determination only at some points (points where structures such as buildings are present in the surroundings, for example) determined in advance.

### Authentication Method 7: Authentication Using Surroundings Information

In the authentication method 7, information used by a different terminal (different tracking apparatus 20, for example) that presents geographically and spatially close to the tracking apparatus 20 is used. In the authentication method 7, it is possible to authenticate the location information of the tracking apparatus 20 through comparison between the information used by the tracking apparatus 20 and the information used by the different terminal.

More specifically, the authentication unit 103 is considered to perform authentication by one or both of (1) and (2) below.

(1) The authentication unit 103 compares information received by the tracking apparatus 20 (for example, an identifier of the mobile base station or the wireless LAN access point, beacon information received by Bluetooth (trade name), information represented by an ambient sound collected by a microphone, or the like) with information received by the different terminal that presents geographically and spatially close to the tracking apparatus 20 (that is, a different terminal that is present within a predetermined distance from the location information of the tracking apparatus 20, for example), for example, and the authentication unit 103 determines that the location information has not been counterfeited in a case in which these pieces of information are similar to each other or are within a predetermined error range, for example, or determines that the location information has been counterfeited otherwise. In a case in which the location information is not determined to have been counterfeited, then the authentication unit 103 authenticates the location information. Note that in this case, each tracking apparatus 20 transmits, in addition to the location information, various kinds of information (for example, the identifier of the mobile base station or the wireless LAN access point, beacon information received by Bluetooth (trade name), information represented by the ambient sound collected by the microphone, or the like) to the authentication apparatus 10. In this regard, the identifier or the like of the wireless LAN access point may be obtained from the aforementioned communication log information.

(2) The authentication unit 103 compares location information of the tracking apparatus 20 during a time period with location information of a different terminal that presents geographically and spatially close to the tracking apparatus 20 (for example, a terminal or the like that is mounted in a vehicle considered to be traveling before or after the vehicle in which the tracking apparatus 20 is mounted) during the time period, and determines that the location information has not been counterfeited in a case in which routes represented by these pieces of location information are similar to each other, or determines that the location information has been counterfeited otherwise. In a case in which the location information is not determined to have been counterfeited, then the authentication unit 103 authenticates the location information.

In this regard, in a case in which two or more authentication methods are used from among the aforementioned authentication methods 1 to 7, the authentication unit 103 may finally authenticate each piece of location information only in a case in which the location information is authenticated by all the authentication methods used for the authentication or may output a final authentication result by weighting authentication results of all the authentication methods used for the authentication and then comparing the weighted authentication result with a predetermined threshold value. For example, on the assumption that a score in a case in which the location information has been authenticated by each of the authentication methods is defined as “+1”, a score in the case in which the location information has not been authenticated by each of the authentication methods is defined as “−1”, and the weights of the authentication methods 1 to 7 are defined as α1 to α7, respectively, it is considered that the authentication unit 103 outputs information indicating that “the location information has been authenticated” as a final authentication result in a case in which the sum of values obtained by multiplying the scores with respect to the authentication results of the authentication methods used for the authentication by the weights exceeds a threshold value, or outputs information indicating that “the location information has not been authenticated” as a final authentication result otherwise.

In addition, which of the aforementioned authentication methods 1 to 7 is to be used can be freely determined. For example, the authentication methods to be used for the authentication of each piece of location information may be fixedly determined in advance for all the tracking apparatuses 20, or the authentication methods to be used for the authentication of each piece of location information may be determined for each tracking apparatus 20.

Further, in a case in which two or more authentication methods are used, authentication may be performed by a plurality of authentication methods at the same time, or authentication may be performed in an order determined in advance. For example, a rule that “authentication is performed by the authentication methods 1 to 3 only in a case in which the authentication has not successfully been performed by the authentication method 4” in a case in which the authentication methods 1 to 4 are used may be employed.

### Supplement

As described above, the authentication system 1 according to the present embodiment authenticates location information collected from the tracking apparatus 20 using one or more authentication methods. Thus, the authentication system 1 according to the present embodiment can authenticate the location information with higher precision using a plurality of authentication methods, in particular. Further, by employing the authentication method using reception state information obtained through ray-tracing simulation from among the authentication methods, it is possible to detect counterfeiting of location information using a GNSS pseudo signal generator, a GNSS simulator or the like with higher precision, and it is thus possible to authenticate the location information with higher precision.

Note that although the authentication system 1 according to the present embodiment is adapted such that the tracking apparatus 20 generates location information and time information, an embodiment is not limited thereto, and the authentication apparatus 10 may generate the location information and the time information, for example. In this case, the tracking apparatus 20 may transmit, to the authentication apparatus 10, data including information (observational data or raw data) represented by signals received from the GNSS satellites in S101 in FIG. 5. In this manner, the authentication apparatus 10 can generate the location information and the time information from the data. In this case, the authentication apparatus 10 can perform the authentication with higher precision by generating the location information and the time information by a high-precision positioning scheme such as a carrier-phase-based positioning, for example.

In addition, although, in the authentication system 1 according to the present embodiment, the authentication apparatus 10 executes the authentication processing illustrated in FIG. 6; an embodiment is not limited thereto, and the tracking apparatus 20 may execute the authentication processing illustrated in FIG. 6, for example (that is, the tracking apparatus 20 may include the acquisition unit 102 and the authentication unit 103). In this case, the tracking apparatus 20 may transmit the authentication result in Step S202 in FIG. 6 and the like to the authentication apparatus 10 (or to a server apparatus or the like that collects the authentication result), for example.

The present invention is not limited to the aforementioned embodiment specifically disclosed above, and various modifications, amendments, combinations, and the like can be made without departing from the scope defined in the appended claims.

### REFERENCE SIGNS LIST

1 Authentication system

10 Authentication apparatus

11 Input device

12 Display device

13 External I/F

13a Recording medium

14 Communication I/F

15 Memory device

16 Processor

17 Bus

20 Tracking apparatus

21 Input device

22 Display device

23 External I/F

23a Recording medium

24 Communication I/F

25 Memory device

26 Processor

27 GNSS receiving set

28 Bus

29 GNSS antenna

30 Communication network

101 Reception unit

102 Acquisition unit

103 Authentication unit

104 Storage unit

201 GNSS reception unit

202 Location information generation unit

203 Time information generation unit

204 Transmission unit

205 Storage unit

1. An authentication system configured to perform authentication of first location information collected from an apparatus, the authentication system comprising a processor, and the processor being configured to:
acquire one or more pieces of authentication information to be used for the authentication; and
determine, using the one or more pieces of authentication information acquired by the processor, whether the first location information is counterfeited, by an authentication method corresponding to each of the one or more pieces of authentication information to authenticate the first location information.

2. The authentication system according to claim 1, wherein the one or more pieces of authentication information includes information corresponding to a position indicated by the first location information.

3. The authentication system according to claim 1,
wherein the one or more pieces of authentication information includes at least traffic information including second location information and information regarding traffic availability at a position indicated by the second location information, and
the processor is further configured to determine whether the first location information is counterfeited using the information regarding the traffic availability in the traffic information including the second location information corresponding to the first location information collected from the apparatus.

4. The authentication system according to claim 3,
wherein the traffic information includes at least traffic light state information including second location information indicating a position of a traffic light and information regarding traffic availability depending on a lighting state of the traffic light, road state information including second location information indicating a position of a road and information regarding traffic availability of the road, and rail crossing state information including second location information indicating a position of a rail crossing and information regarding traffic availability depending on an open/closed state of a crossing bar of the rail crossing, and
the processor is further configured to
determine, when having acquired the traffic light state information, whether the first location information is counterfeited using the first location information in a predetermined time period and the traffic light state information corresponding to a traffic light that controls traffic at a position indicated by the first location information,
determine, when having acquired the road state information, whether the first location information is counterfeited using the first location information in a predetermined time period and the road state information corresponding to a road including a position indicated by the first location information, and
determine, when having acquired the rail crossing state information, whether the first location information is counterfeited using the first location information in a predetermined time period and the rail crossing state information corresponding to a rail crossing on a road including a position indicated by the first location information.

5. The authentication system according to claim 1,
wherein the one or more pieces of authentication information includes at least communication log information of a mobile base station or a wireless LAN access point used by the apparatus, and
the processor is further configured to determine, when having acquired the communication log information, whether the first location information is counterfeited by determining whether the communication log information including an identifier of the mobile base station or the wireless LAN access point used by the apparatus to transmit the first location information at a position indicated by the first location information is present.

6. The authentication system according to claim 1,
wherein the one or more pieces of authentication information includes at least one of communication log information of a mobile base station or a wireless LAN access point used by the apparatus, beacon information received by the apparatus, or information represented by an ambient sound collected by the apparatus, and
the processor is further configured to determine, when having acquired the communication log information, the beacon information, the information represented by the ambient sound, or any combination thereof, whether the first location information is counterfeited by comparing the communication log information, the beacon information, the information represented by the ambient sound, or any combination thereof that is acquired with communication log information of a mobile base station or a wireless LAN access point used by a different apparatus that is present within a predetermined range from the apparatus, beacon information received by the different apparatus, information represented by an ambient sound collected by the different apparatus, or any combination thereof.

7. The authentication system according to claim 1,
wherein the one or more pieces of authentication information includes at least the first location information, and
the processor is further configured to determine, when having acquired the first location information, whether the first location information is counterfeited by comparing the first location information in a predetermined time period with location information in the predetermined time period of a different apparatus that is present within a predetermined range from the apparatus.

8. The authentication system according to claim 1,
wherein the one or more pieces of authentication information includes at least reception state information indicating a result of simulating a reception state of a radio wave from a GNSS satellite in a 3D space, and
the processor is further configured to determine, when having acquired the reception state information, whether the first location information is counterfeited by comparing a reception state of a radio wave from a GNSS satellite at a position indicated by the first location information with a simulation result indicated by the reception state information.

9. The authentication system according to claim 8, wherein the reception state includes an SN ratio of the radio wave, reception intensity of the radio wave, whether multipath propagation occurs when the radio wave is received, or any combination thereof.

10. The authentication system according to claim 9, wherein the authentication section determines whether the first location information is counterfeited, from a weighted sum of determination results of authentication methods respectively corresponding to the one or more pieces of authentication information.

11. An authentication method that is an authentication procedure performed by an authentication system that includes a processor and performs authentication of location information collected from an apparatus, the method comprising:
Acquiring, by the processor, one or more pieces of authentication information to be used for the authentication; and
determining, by the processor, using the one or more pieces of authentication information acquired in the acquiring, whether the location information is counterfeited, by an authentication method corresponding to each of the one or more pieces of authentication information to authenticate the location information.

12. A non-transitory computer-readable medium storing a program configured to cause a computer of an authentication system to perform authentication of first location information collected from an apparatus, the program being configured to further cause the computer to:
acquire one or more pieces of authentication information to be used for the authentication; and
determine, using the one or more pieces of authentication information acquired by the computer, whether the first location information is counterfeited, by an authentication method corresponding to each of the one or more pieces of authentication information to authenticate the first location information.
